(19) United States
(12) Patent Application Publication
(10) Pub. No.: US 2017/0364932 A1
(43) Pub. Date: Dec. 21, 2017

(54) DATA WAREHOUSE FOR MINING SEARCH QUERY LOGS

(71) Applicant: Amadeus S.A.S., Biot (FR)

(72) Inventors: Benoit Lardeux, Roquefort-les-Pins (FR); Rodrigo Alejandro Acuna Agost, Golfe Juan (FR)

(21) Appl. No.: 15/188,228

(22) Filed: Jun. 21, 2016

(51) Int. Cl. G06Q 30/02; G06F 17/30; G06Q 50/14

(52) U.S. Cl. CPC G06Q 30/0202; G06Q 50/14; G06F 17/30592; G06F 17/30551; G06F 17/30241; G06F 17/30525; G06F 17/30477; G06F 17/30336; G06F 17/30528

(57) ABSTRACT

Systems, methods, and computer program products for mining search query logs. A data warehousing system includes a query database that stores data relating to search queries, a reservation history database that stores data relating to booked products, and a data warehousing application that extracts and processes the search query and booking data from the query and reservation history databases to produce statistical data. The data warehousing application generates historical query, booking, and specific flight booking pickup curves based on the extracted statistical data. A weighted average of the historical query and booking pickup curves is determined that provides a best fit with the flight specific pickup curve. A weighting factor that produced the best fit is then used to forecast demand for future flights.

### BACKGROUND

The invention generally relates to computers and computer software and, in particular, to methods, apparatus, and computer program products for analyzing large quantities of data related to search queries received by a travel management system.

The travel industry has grown significantly over the past decades, which has led to an increase in both the number of travel providers and the amount of data to be managed among those providers. As the number of providers has increased, intermediaries have appeared that provide travel management systems. These travel management systems manage communication between the travel provider and the end user, thereby enabling users of travel agency systems, airline reservation systems, and travel web sites to retrieve information from a large number of travel provider systems.

These users often submit low-fare-search (LFS) queries when searching for flights. LFS queries typically define an origin, a destination, and one or more dates and/or times when travel between the origin and destination is desired. Travel management systems typically respond to these LFS queries by determining a set of one or more flights between the origin and destination, and a fare that can be used with each flight. The fares may be determined by a fare engine that uses tariff data published by a tariff data provider, such as the Airline Tariff Publishing Company (ATPCO), to calculate the fares. The search results typically include a list of travel options that include flight and fare price information.

LFS queries are often used to identify potential flights in the early stages of planning a trip. Thus, users typically submit multiple LFS queries before selecting and booking a flight. Travelers without specific travel plans may also submit queries in order to determine where they would like to travel, or out of mere curiosity. The number of LFS queries received by travel management systems may therefore exceed the number of spaces that are ultimately booked by a large factor. Due to the large number of LFS queries received, travel systems may have difficulty managing LFS queries, and typically discard LFS queries after they have been answered. Conventional travel management systems are therefore unable to provide detailed information related to LFS queries that have been received over a period of time.

Thus, improved systems, methods, and computer program products for managing and analyzing LFS queries are needed to improve the ability of travel management systems to track and provide information relating to LFS queries.

### SUMMARY

In an embodiment of the invention, a data warehouse system is provided. The system includes one or more processors, and a memory coupled to the processors. The memory stores first data comprising a first database of query log records, and instructions that, when executed by at least one of the processors, causes the system to receive a plurality of search queries. Each search query may be received at a reception time, and may define a departure time and an origin-destination pair. The instructions may further cause the system to, for each search query, determine a time until departure from the reception time to the departure time of the search query, and store, in a query log record associated with the origin-destination pair, second data indicating reception of the search query and the time to departure. Each query log record may also indicate a number of spaces and the time to departure associated with each space for the origin-destination pair with which the query log record is associated.

In another aspect of the invention, the instructions may further cause the system to define an index including a plurality of fields each corresponding to a respective origin-destination pair. Each field may define a location in the first database of each query log record that is associated with the respective origin-destination pair.

In another aspect of the invention, the instructions may further cause the system to receive a request to provide statistical data for a respective origin-destination pair for a period of time. In response to receiving the request, the system may retrieve one or more query log records from the first database. Each of the one or more query log records that are retrieved may be associated with the respective origin-destination pair, and may include data relating to search queries that define a respective departure time which falls within the period of time. The system may extract the second data from each of the retrieved query log records, generate a first pickup curve depicting an intensity of search queries for the respective origin-destination pair with respect to the time to departure during the period of time based on the second data, and forecast a demand for spaces for the respective origin-destination pair using the first pickup curve.

In another aspect of the invention, the period of time may cover a plurality of departure intervals, and the instructions may cause the system to forecast the demand for spaces for the respective origin-destination pair using the first pickup curve by querying a second database for third data that defines a plurality of bookings of spaces for the respective origin-destination pair that have departed during the period of time. The system may further generate a second pickup curve using the third data, the second pickup curve depicting a number of bookings with respect to the time to departure during the period of time. The system may generate a third pickup curve that is a weighted average of the first pickup curve and the second pickup curve. The demand for spaces may then be forecast for the respective origin-destination pair using the third pickup curve.

In another aspect of the invention, the instructions may further cause the system to, for at least one departure interval covered by the period of time, determine a target pickup curve for the respective origin-destination pair, determine a weighting factor that provides a best fit between the third pickup curve and the target pickup curve, and forecast the demand for spaces for the respective origin-destination pair for a future departure interval using the third pickup curve with the weighting that provides the best fit.

In another aspect of the invention, the instructions may further cause the system to, for each future departure interval, determine a partial pickup curve for the search queries that were satisfied by a respective travel solution for the respective origin-destination pair that is scheduled to depart during the future departure interval, determine the third pickup curve having the best fit to the partial pickup curve, and forecast the demand for spaces for the respective origin-destination pair for the future departure interval using the third pickup curve having the best fit to the partial pickup curve.

In another aspect of the invention, the respective origin-destination pair may be one of a plurality of origin-destination pairs comprising a travel network, and the instructions may further cause the system to generate a separate first pickup curve for each departure interval for each origin-destination pair of the plurality of origin-destination pairs.

In other aspects of the invention, the search queries may be low fare search queries, the departure time defined by each of the one or more query log records may have passed at the time the request is received, each departure interval may cover a day, and/or the period of time may cover a year.

In another embodiment of the invention, a method of processing the transaction is provided. The method may include receiving the plurality of search queries by the data warehouse system. Each search query may be received at the reception time and may define the departure time and the origin-destination pair. The method may further include, for each search query, determining the time until departure from the reception time to the departure time of the search query, and storing, in the query log record associated with the origin-destination pair, the second data indicating reception of the search query and the time to departure. Each query log record may be stored in the first database, and may indicate the number of spaces and the time to departure associated with each space for the origin-destination pair with which the query log record is associated.

In another embodiment of the invention, a computer program product is provided. The computer program product may include a non-transitory computer-readable storage medium, and program code stored on the medium. When executed by one or more processors, the program code may cause the processors to receive the plurality of search queries. Each search query may be received at the reception time and may define the departure time and the origin-destination pair. For each search query, the program code may cause the processors to determine the time until departure from the reception time to the departure time of the search query, and store, in the query log record associated with the origin-destination pair, the second data indicating the reception of the search query and the time to departure. Each query log record may indicate the number of spaces and the time to departure associated with each space for the origin-destination pair with which the query log record is associated.

The above summary may present a simplified overview of some embodiments of the invention in order to provide a basic understanding of certain aspects the invention discussed herein. The summary is not intended to provide an extensive overview of the invention, nor is it intended to identify any key or critical elements, or delineate the scope of the invention. The sole purpose of the summary is merely to present some concepts in a simplified form as an introduction to the detailed description presented below.

### BRIEF DESCRIPTION OF THE DRAWINGS

The accompanying drawings, which are incorporated in and constitute a part of this specification, illustrate various embodiments of the invention and, together with the general description of the invention given above, and the detailed description of the embodiments given below, serve to explain the embodiments of the invention.

FIG. 1 is a diagrammatic view of an exemplary operating environment including a travel management system in communication with a query database and a reservation history database.

FIG. 2 is a diagrammatic view of an exemplary computer that may be used to provide the operating environment of FIG. 1.

FIG. 3 is a diagrammatic view a data warehousing system including a demand forecasting module and a data collection module in communication with the search query and reservation history databases of FIG. 1.

FIG. 4 is a graphical view of a pair of pickup curves that may be generated by the demand forecasting module of FIG. 3.

FIG. 5 is a graphical view of the pickup curves from FIG. 4 and a query pickup curve that may be generated using data extracted from the query database of FIG. 1.

FIG. 6 is a flow chart of a process for determining a weighting factor that may be used to incorporate search query data into the forecasting process.

FIG. 7 is a graphical view of a historical query pickup curve and a prospective query pickup curve that may be used to correct a previous demand forecast.

FIG. 8 is a flow chart of a process that corrects the demand forecast using the historical query pickup curve and the prospective query pickup curve of FIG. 7.

### DETAILED DESCRIPTION

Embodiments of the invention may be implemented by a data processing system that provides database functions which store, index, categorize, and organize search queries received by a travel management system. The travel management system may be configured to facilitate interconnections between one or more computer and database systems. The computer and database systems may include one or more provider systems, database management systems, user systems, and/or any other computer systems associated with providing travel products. In the context of air travel, the travel management system may allow travelers to search for and book airline tickets across multiple sales channels and/or providers of travel products. A data warehouse system may be configured to collect and mine data relating to search queries received by the travel management system, and populate new database records and/or systems with data based on the mined data in a processed form that can be quickly and easily analyzed.

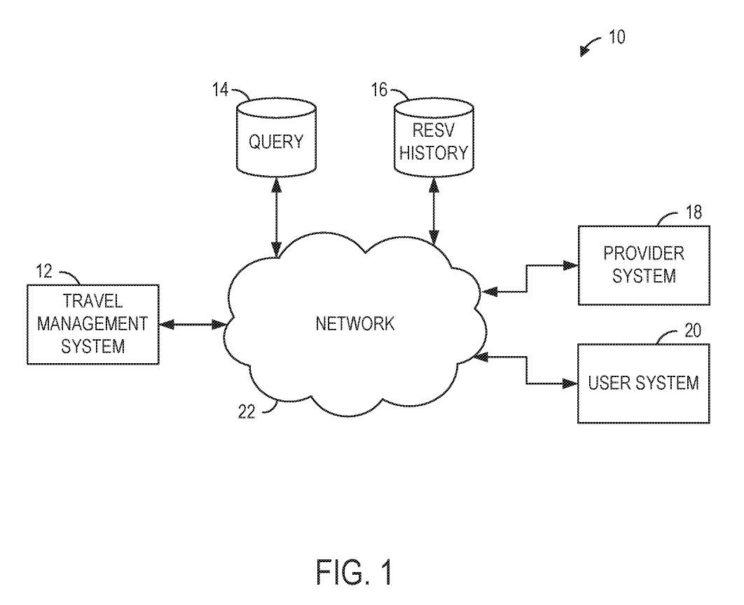

Referring now to FIG. 1, an operating environment 10 in accordance with an embodiment of the invention may include a travel management system 12, a query database 14, a reservation history database 16, a provider system 18, and a user system 20. Each of the travel management system 12, query database 14, reservation history database 16, provider system 18, and user system 20 may communicate through a network 22. The network 22 may include one or more private or public data networks (e.g., the Internet) that enable the exchange of data between systems connected to the network 22.

The travel management system 12 may be configured to receive and process queries from the user system 20. The user system 20 may be a travel agency system, airline reservation system, travel web site system, or any other system used to search for, reserve, and purchase travel products. The queries received by the travel management system 12 may include, for example, search queries, such as Low-Fare Search (LFC) queries. Each search query may include one or more search terms. Search terms may include, for example, an origin, a destination, an amount of space required, and a period of time during which travel is desired. In response to receiving a search query, the travel management system 12 may interrogate one or more reservation systems, cache databases, or any other suitable source of priced travel solutions matching the search terms in the search query. The travel management system 12 may process and return all or a portion of the received priced travel solutions to the user system 20 as search results.

The search queries, and/or data relating to, defining, or otherwise characterizing the search queries, may be stored in the query database 14. Data relating to the search queries may include the origin and destination defined by the search query, a time the search query was received by the travel management system 12 (or “reception time”), a number of spaces requested for travel from the origin to the destination, times when travel was desired, or any other parameter defined by, or relating to, the search queries.

Prior to reserving a flight, a user (e.g., the traveler or a travel agent working for the traveler) may search for travel solutions that satisfy the requirements of the traveler. To this end, the user may enter search terms into a client application, such as a web-browser or a reservation application running on the user system 20. The client application may then transmit a search query including the search terms to a corresponding server application of the travel management system 12. The user may perform multiple searches over a period of time before selecting and reserving one or more spaces, or “space”, on a travel solution. These searches may be performed during a single session, or may be performed in separate sessions over a period of time. In either case, the user may eventually book space on a travel solution or decide to forego the trip, at which point the user may stop searching for travel solutions.

In response to receiving a search query from the client application, the server application may determine which travel solutions satisfy the search terms. The server application may also search the query database 14 for query log records corresponding to an origin-destination pair defined by the search query. If a query log record is not found for the origin-destination pair, the server application may request the query database 14 create a record. Each query log record may correspond to a specific origin-destination pair and a specific departure interval, e.g., a specific day, week, or other period of time over which demand is to be predicted. The query log record may also correspond, either in addition to or instead of the departure interval, a specific flight. The query database 14 may, in addition to or instead of the query log records, store the search queries themselves or any other data relating to the search queries.

Each query log record may include one or more fields for storing data. These fields may include, for example, an origin field containing data that defines the origin, a destination field containing data that defines the destination, a departure interval and/or flight field containing data that defines the departure period, and a counter field containing data that defines how many times a search query has been received by the server application with search terms matching the origin-destination pair, and a time at which each of the matching queries was received. When a search query is received by the server application, the server application may add data to the counter field in each matching query log record to indicate a matching search query was received. The counter field may also include data indicating the number of spaces requested by each search query. For example, the counter field may include a counter that is incremented by the number of spaces requested by the search query each time a search query is received which matches the query log record.

The reservation history database 16 may store data relating to reservations that have been booked. Once one or more suitable travel solutions are identified by the user, the user system 20 may transmit a request to the server application requesting that space in the travel solution or solutions be booked. This request may be forwarded to one or more of the reservation systems. If the request is accepted by the reservation systems, a reservation may be made (e.g., by creating a passenger name record in a passenger name record database), and an inventory of available spaces in the corresponding booking class of the travel solution reduced by the number of spaces being booked.

In response to receiving confirmation from the reservation system or systems that the requested space has been booked, the server application may request the reservation history database 16 create and/or modify a booking record to indicate that the corresponding space was booked, and the time at which the space was booked. This data may be saved in the reservation history database for a period of time (e.g., a year) after the flights corresponding to the booking records have departed.

The provider system 18 may include a Computer Reservation System (CRS) that enables the travel management system 12 to reserve and pay for travel products, such as airline tickets, hotel rooms, or rental vehicles. For providers of air travel, the CRS may manage reservations for spaces between nodes of a travel network. Each node of the travel network may comprise a station (e.g., an airport) to and from which the provider operates flights. The provider system 18 may also interact with other provider systems either directly or through the travel management system 12, to enable a validating carrier to sell tickets for spaces provided by the operating carrier. The operating carrier may then bill the validating carrier for the products provided.

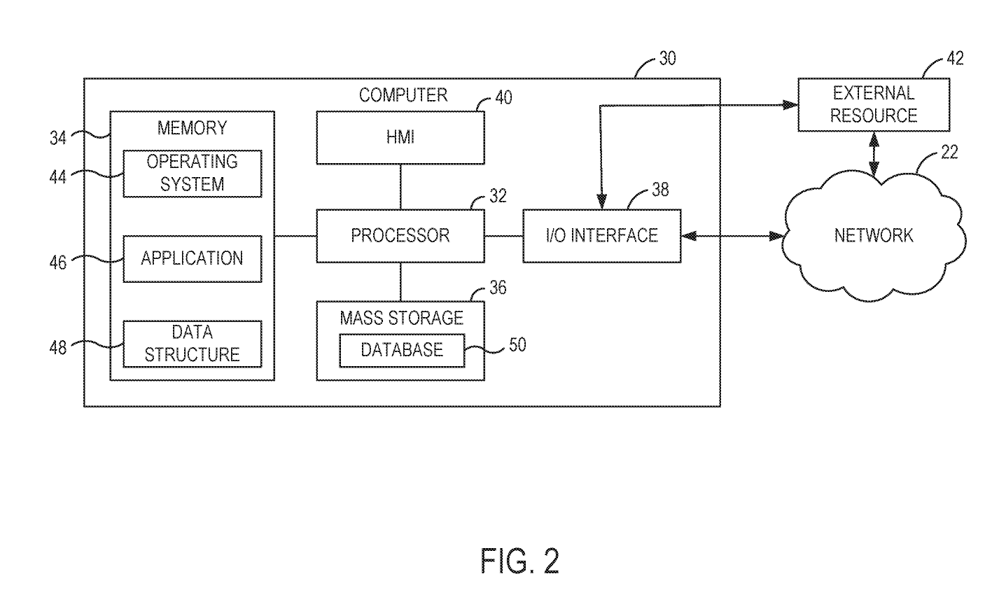

Referring now to FIG. 2, the travel management system 12, query database 14, reservation history database 16, provider system 18, user system 20, and network 22 of operating environment 10 may be implemented on one or more computer devices or systems, such as exemplary computer 30. The computer 30 may include a processor 32, a memory 34, a mass storage memory device 36, an input/output (I/O) interface 38, and a Human Machine Interface (HMI) 40. The computer 30 may also be operatively coupled to one or more external resources 42 via the network 22 or I/O interface 38. External resources may include, but are not limited to, servers, databases, mass storage devices, peripheral devices, cloud-based network services, or any other suitable computer resource that may be used by the computer 30.

The processor 32 may include one or more devices selected from microprocessors, micro-controllers, digital signal processors, microcomputers, central processing units, field programmable gate arrays, programmable logic devices, state machines, logic circuits, analog circuits, digital circuits, or any other devices that manipulate signals (analog or digital) based on operational instructions that are stored in memory 34. Memory 34 may include a single memory device or a plurality of memory devices including, but not limited to, read-only memory (ROM), random access memory (RAM), volatile memory, non-volatile memory, static random access memory (SRAM), dynamic random access memory (DRAM), flash memory, cache memory, or any other device capable of storing data. The mass storage memory device 36 may include data storage devices such as a hard drive, optical drive, tape drive, volatile or non-volatile solid state device, or any other device capable of storing data.

The processor 32 may operate under the control of an operating system 44 that resides in memory 34. The operating system 44 may manage computer resources so that computer program code embodied as one or more computer software applications, such as an application 46 residing in memory 34, may have instructions executed by the processor 32. The processor 32 may also execute the application 46 directly, in which case the operating system 44 may be omitted. The one or more computer software applications may include a running instance of an application comprising a server, which may accept requests from, and provide responses to, one or more corresponding client applications. One or more data structures 48 may also reside in memory 34, and may be used by the processor 32, operating system 44, and/or application 46 to store or manipulate data.

The I/O interface 38 may provide a machine interface that operatively couples the processor 32 to other devices and systems, such as the network 22 or external resource 42. The application 46 may thereby work cooperatively with the network 22 and/or external resource 42 by communicating via the I/O interface 38 to provide the various features, functions, applications, processes, or modules comprising embodiments of the invention. The application 46 may also have program code that is executed by one or more external resources 42, or otherwise rely on functions or signals provided by other system or network components external to the computer 30. Indeed, given the nearly endless hardware and software configurations possible, it should be understood that embodiments of the invention may include applications that are located externally to the computer 30, distributed among multiple computers or other external resources 42, or provided by computing resources (hardware and software) that are provided as a service over the network 22, such as a cloud computing service.

The HMI 40 may be operatively coupled to the processor 32 of computer 30 to enable a user to interact directly with the computer 30. The HMI 40 may include video or alphanumeric displays, a touch screen, a speaker, and any other suitable audio and visual indicators capable of providing data to the user. The HMI 40 may also include input devices and controls such as an alphanumeric keyboard, a pointing device, keypads, pushbuttons, control knobs, microphones, etc., capable of accepting commands or input from the user and transmitting the entered input to the processor 32.

A database 50 may reside on the mass storage memory device 36, and may be used to collect and organize data used by the various systems and modules described herein. The database 50 may include data and supporting data structures that store and organize the data. In particular, the database 50 may be arranged with any database organization or structure including, but not limited to, a relational database, a hierarchical database, a network database, an object-oriented database, or combinations thereof.

A database management system in the form of a computer software application executing as instructions on the processor 32 may be used to access data stored in records of the database 50 in response to a query, where the query may be dynamically determined and executed by the operating system 44, other applications 46, or one or more modules. Although embodiments of the invention may be described herein using relational, hierarchical, network, object-oriented, or other database terminology in specific instances, persons having ordinary skill in the art will understand that embodiments of the invention may use any suitable database management model, and are not limited to any particular type of database.

In the context of air travel, a “market” may refer to one-way travel between a specific origin and a specific destination, or origin-destination pair. The demand for space in a market may refer to the number of spaces that customers would book in the market if the supply was unlimited. Spaces in a market may be spread across multiple flights and/or providers. An provider's inventory may contain all flights with their available seats. A space may be distinguished from a seat based on the concept of overbooking. Overbooking refers to the practice by which providers book more spaces than there are physical seats on a flight in anticipation that some booked spaces will go unused due to passengers failing to show up at the time of departure. Demand may depend on factors such as the price of spaces and the time at which the spaces depart from the origin. For example, demand in a particular market may vary based on the price, the day of the week the flight departs, and/or the time of year.

A segment may refer to the operation of an aircraft between one point where passengers first board the aircraft and another point where the passengers exit the aircraft for a final time. A segment may include any number of stops where passengers can exit and re-board the same aircraft. A leg may refer to the operation of an aircraft from one scheduled departure station to its next scheduled arrival station. Thus, a segment may include one or more legs flown by a single aircraft.

A flight may refer to the operation of one or more segments with the same flight designator, and may involve more than one aircraft. A travel solution may refer to a combination of one or more flights that provides one-way travel from a specific origin to a specific destination, and that departs from the origin at a specific time. Thus, a travel solution may include a specific instance of travel between an origin and a destination. Travel solutions matching the search terms of a search query may be returned as a search result, and if a space is available on the travel solution, the space may be booked by the searcher for travel from the origin to the destination.

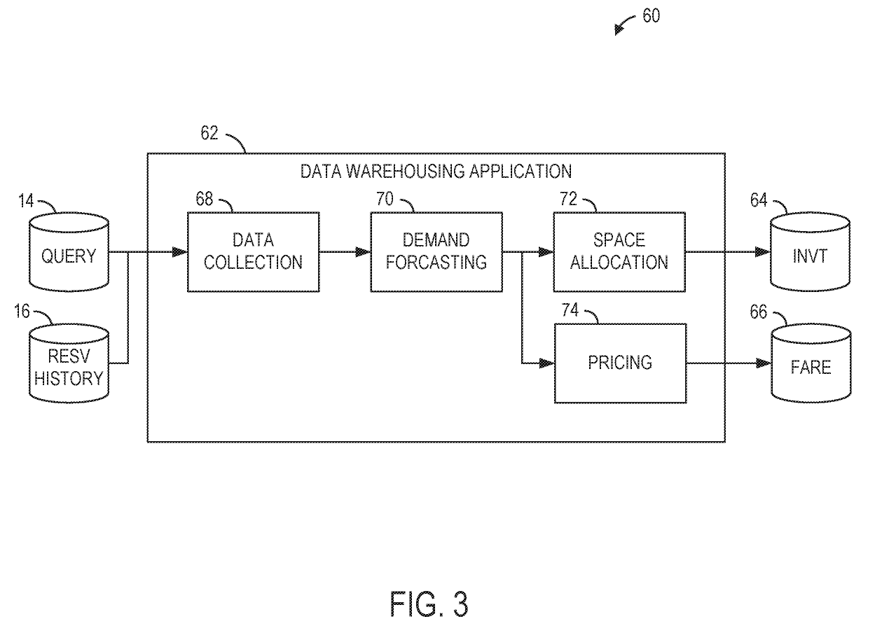

FIG. 3 depicts a data warehouse system 60 that may encompass one or more of the query database 14, the reservation history database 16, a data warehousing application 62, an inventory database 64, and/or a fare database 66. The data warehousing application 62 may be hosted by the travel management system 12, or another suitable system, and may provide reporting and data analysis functions. To this end, the data warehousing application 62 may include a data collection module 68, a demand forecasting module 70, a space allocation module 72, and a pricing module 74. These modules may retrieve current and historical data from the query database 14 and reservation history database 16, use this data to create analytical reports and/or data, and warehouse the reports and/or data in one or more of the inventory database 64 and fare database 66. These analytical reports and/or data may include demand forecasts, pickup curves, space allocation recommendations, and/or pricing recommendations.

The data collection module 68 may retrieve current and historical data relating to a number of search queries received for travel in each market from the query database 14, and historical data relating to a number of spaces booked in each market from the reservation history database 16. The demand forecasting module 70 may use the data collected by the data collection module 68 to forecast demand for space in each market. These forecasts may be used by the space allocation module 72 to issue reports and/or allocate space in an inventory database 64, and by the pricing module 74 to issue reports and/or set fares in the fare database 66. In an embodiment of the invention, the fare database 66 may be managed by ATPCO.

The space allocation module 72 and pricing module 74 may operate cooperatively to maximize carrier revenue by establishing a plurality of fare classes within each market served by the carrier, allocating the carrier's inventory between the classes, and setting a price for units of inventory (e.g., spaces) in each class. The demand forecasting module 70 may monitor demand for tickets within each fare class relative to the forecast demand, and update the demand forecast based thereon. The amount of inventory made available in, as well as the pricing of, each fare class for each flight in each market may in turn be adjusted by the space allocation module 72 and pricing module 74 based on the updated demand forecast. The objective of the space allocation module 72 and pricing module 74 may be to allocate enough inventory to discount-fare passengers so that each aircraft departs with a full load, but to not allocate so much inventory to earlier-booking discount-fare passengers that any later-booking full-fare passengers are unable to reserve space on the flight.

If demand is forecast precisely, the space allocation module 72 and pricing module 74 may set prices and allocate inventory in a way that allows each flight to be full or nearly full without turning away any full-fare passengers due to the sale of a ticket to a discount-fare passenger. Conventional systems may predict future demand based largely on the historical demand for space in each market. This reliance on previous demand can result in forecasting errors. Forecasting errors can lead to sub-optimal allocation of available capacity between markets and between classes within each market.

For example, if forecast demand is less than actual demand, too many spaces may be made available to discount passengers. This may result in spaces selling out early so that later booking full-fare passengers cannot purchase a ticket. On the other hand, if forecast demand is greater than actual demand, too few spaces may be made available to discount passengers early enough in the booking period. This may result in aircraft departing with empty seats when the forecast demand fails to materialize. Forecasting errors may also lead to sub-optimal pricing of inventory. For at least these reasons, forecasting errors may result in the provider receiving less revenue than would have been possible had demand been accurately predicted.

Forecasting and optimization may provide two sets of information that can be used for revenue management. Forecasting may predict how many spaces will be booked in a market, and when the bookings will occur relative to the time of departure. Optimization may determine, based on this forecast demand, the how many spaces to make available in each booking class in the market, and when the spaces should be made available for booking, i.e., when to open and close each booking class.

Because space allocation and pricing decisions are rooted in forecast demand, accurate demand forecasting has a direct impact on operation of the data warehouse system 60. Carriers may use forecast demand to determine the amount of capacity to supply. Near-term forecasts may be used to make decisions such as pricing and allocation of capacity between booking classes for scheduled flights. Longer term forecasts may be used to make decisions regarding routes on which to bid, which markets to enter, and the number and type of equipment to purchase or lease.

Referring now to table 1, an exemplary pickup table is depicted for bookings for departed flights in a particular market. Table 1 may be generated, for example, using data stored in the reservation history database 16. The pickup table depicted includes columns and rows that define cells, with each cell including data that is associated with the row and the column which defines the cell. Each cell may be associated with a pointer that points to a memory location where the data in the cell is stored. The data may be calculated from data stored in the reservation history database 16 as needed, or may be previously calculated and stored in memory.

The data in each cell may define a number of spaces that were booked in the market at a specified time prior to the end of a booking period (e.g., the number of booked spaces x days prior to departure), with the specified time corresponding to the respective column. The columns may be arranged in order of increasing amount of time prior to departure, with the leftmost column (e.g., column A) corresponding to the least amount of time until departure (e.g., one day), and the rightmost column (e.g., column I) corresponding to the greatest amount of time until departure (e.g., 360 days). The number of spaces in each cell may be for spaces that departed during a departure interval (e.g., all flights departing on a daily basis) corresponding to the cell's respective row. In an embodiment of the invention, the data in the pickup table may also include spaces that are scheduled to depart. That is, the table may include data for flights that have not yet departed.

TABLE 1

| Departure | Time Prior to Departure | | | | | | | | |
|---|---|---|---|---|---|---|---|---|---|
| Interval | A | B | C | D | E | F | G | H | I |
| +4 | — | — | — | — | 17 | 13 | 2 | 0 | 0 |
| +3 | — | — | — | 23 | 16 | 6 | 4 | 2 | 1 |
| +2 | — | — | 40 | 21 | 15 | 3 | 1 | 1 | 0 |
| +1 | — | 62 | 37 | 22 | 13 | 5 | 3 | 2 | 1 |
| 0 | 100 | 60 | 36 | 22 | 13 | 8 | 4 | 3 | 1 |
| −1 | 96 | 57 | 37 | 20 | 17 | 4 | 3 | 0 | 0 |
| −2 | 103 | 60 | 38 | 21 | 12 | 8 | 4 | 2 | 1 |
| −3 | 99 | 59 | 36 | 22 | 12 | 7 | 4 | 3 | 1 |
| −4 | 98 | 58 | 36 | 21 | 13 | 12 | 5 | 1 | 0 |

The booking period may define a length of time during which spaces may be booked for departure during the corresponding departure interval. Typical booking periods may cover a relatively long period of time, e.g., six to twelve months, while a typical departure interval may cover a relatively shorter period of time, e.g., one to seven days. The booking period may be covered by the columns of table 1, such that the rightmost column (e.g., column I) represents the earliest time before departure at which the travel solution may be booked (e.g., one year prior to the departure date). It should be understood that the booking period, departure interval, number of rows, and number of columns of table 1 are for exemplary purposes only, and embodiments of the invention are not limited to any particular durations of time or sizes of table.

Each column may correspond to a sample time prior to, or on a departure date for, spaces in the corresponding row. These sample times may be spaced equally (e.g., at intervals of a day or a week), or at staggered times with spacing that changes as the specified time until departure decreases (e.g., so that the interval between columns decreases as the departure date approaches).

As an example of staggered times, column A may represent a total number of spaces booked at the time of departure for flights departing during the departure interval (e.g., all flights departing on day “0”, day “1”, etc.), column B may represent the total number of spaces booked at 7 days prior to departure, column C may represent the total number of spaces booked at 14 days prior to departure, column D may represent the total number of spaces booked at 21 days prior to departure, column E may represent the total number of spaces booked at 28 days prior to departure, column F may represent the total number of spaces booked at 60 days prior to departure, column G may represent the total number of spaces booked at 90 days prior to departure, column H may represent the total number of spaces booked at 180 days prior to departure, and column I may represent the total number of spaces booked at 360 days prior to departure.

The departure interval may correspond to the length of time between each row of table 1, and may define a sample rate for analyzing bookings. The departure interval may be different than the spacing of the sample times, or may coincide with the spacing of the sample times. The departure interval would coincide with the sample time spacing, for example, if both the departure interval and spacing between sample times for the travel solution was one day.

For the above exemplary values with sample times of one week and a departure interval of one day, the cell defined by row 0 and column A of table 1 would indicate that a total of 100 seats had been booked at the time of departure for flights that departed on day 0, which may be the most recent departure interval available for which all spaces of the travel solution have departed. The cell defined by row 0 and column B of table 1 would further indicate that one week prior to day 0 (i.e., day −7), 60 seats were booked on flights departing on day 0. This may indicate that 40 seats were booked for flights leaving on day 0 during the last week of the booking period. Similarly, the cell defined by row −1 and column A of table 1 would indicate that a total of 96 seats were booked by departure time on flights departing on departure interval −1, which would be the day prior to departure interval 0 (i.e., day −1).

Quantitative forecasting may use historical data to predict future demand. This type of forecasting may be based on an assumption that historical trends will continue. Quantitative forecasting may use time based statistical methods such as trend projection and moving averages to predict future demand based on historical data. Using the data in table 1 as an example, one type of quantitative analysis may determine an average number of bookings picked up between sample times (e.g., between A, B, C, and D) for departure intervals that have been flown (e.g., departure intervals 0, −1, −2, −3, and −4). The booking pickup PU_{D} between sample times x and y for a particular departure interval D may be expressed as:

PU_{D}(x,y)=N_{D}(y)−N_{D}(x) Eqn. 1

The average pickup PU_{AVG} may be determines using:

$${PU}_{AVG} ( x , y ) = \frac{1}{n} \times {\sum }_{k = 0}^{n} {PU}_{k} ( x , y ) \qquad Eqn . 2$$

where n is the number of departure intervals over which the average is determined. It should be understood that equations 1 and 2 are exemplary only, and other methods of determining demand may be used by embodiments of the invention. For example, averages could be weighted based on how recent the data is, or determined by only summing bookings departing on days of the week that match the departure interval for which bookings are being estimated.

Applying the above described method the exemplary numbers in table 1 by adding booking pickup numbers to the existing number of bookings in cells of the yet to be flown departure intervals (e.g., departure intervals +4, +3, +2, +1) to predict the number of bookings that will be receive may produce the results shown in table 2.

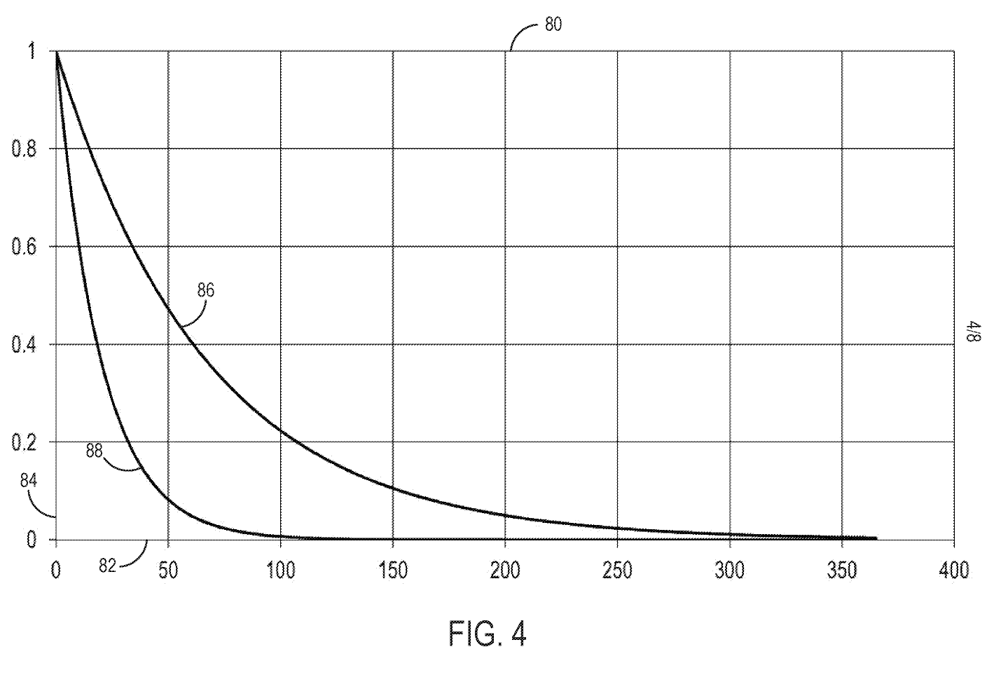

Referring now to FIG. 4, and for purposes of illustration only, an exemplary graph 80 includes a horizontal axis 82 corresponding to a number of days until departure, and a vertical axis 84 corresponding to a number of booked spaces normalized to the total number of spaces booked at departure. It should be understand that the scales of horizontal axis 82 and vertical axis 84 may be distorted in order to more clearly describe embodiments of the invention.

The graph 80 includes pickup curve 86, which may represent low-fare bookings, and pickup curve 88, which may represent full-fare bookings. The demand forecasting module 70 may generate pickup curves 86 and 88 by analyzing reservation records of departed flights. These reservation records may be selected from a pool of records stored in the reservation history database 16 to forecast demand for a specific market or combination of markets. Each of the pickup curves 86, 88 may be based on historical data collected from departed flights in the one or more markets being analyzed. Although the present example depicts pickup curves for two booking classes for purposes of clarity, it should be understood that embodiments of the invention may use curves for any number of booking classes.

TABLE 2

| Departure | Time Prior to Departure | | | | | | | | |
|---|---|---|---|---|---|---|---|---|---|
| Interval | A | B | C | D | E | F | G | H | I |
| +4 | 103 | 62 | 40 | 25 | 17 | 13 | 2 | 0 | 0 |
| +3 | 101 | 61 | 38 | 23 | 16 | 6 | 4 | 2 | 1 |
| +2 | 102 | 62 | 40 | 21 | 15 | 3 | 1 | 1 | 0 |
| +1 | 102 | 62 | 37 | 22 | 13 | 5 | 3 | 2 | 1 |
| 0 | 100 | 60 | 36 | 22 | 13 | 8 | 4 | 3 | 1 |
| −1 | 96 | 57 | 37 | 20 | 17 | 4 | 3 | 0 | 0 |
| −2 | 103 | 60 | 38 | 21 | 12 | 8 | 4 | 2 | 1 |
| −3 | 99 | 59 | 36 | 22 | 12 | 7 | 4 | 3 | 1 |
| −4 | 98 | 58 | 36 | 21 | 13 | 12 | 5 | 1 | 0 |

As can be seen from the relative positions of pickup curve 86 and pickup curve 88, bookings for discount-fare spaces in this example tended to occur earlier with respect to the departure time of the flight than bookings for full-fare spaces. To predict future demand in a market, the demand forecasting module 70 may generate a “model” pickup curve based on a weighted average of pickup curves for several booking classes. For example, in a given market, the model pickup curve may be provided by:

fₘ(t)=w₁×f_{F1}(t)+w₂×f_{F2}(t)

where t represents the time until departure, fₘ(t) represents the model pickup curve, f_{F1}(t) represents the pickup curve for booked spaces in one booking class (e.g., full-fare spaces), f_{F2}(t) represents the pickup curve for booked spaces in another booking class (e.g., discount-fare spaces), w₁ represents a weight applied to f_{F1}(t), and w₂ represents a weight applied to f_{F2}(t). By way of example only, in a particular market having a full-fare booking class and a discount-fare booking class, the weight applied to the full-fare bookings may be 0.30, and the weight applied to the discount fare bookings may be 0.70.

Demand forecasts based on historical bookings may be computed for all flights that are scheduled to depart within a predetermined timeframe, such as one year. Remaining demand can then be determined based on time to departure using the model pickup curve. This remaining demand may be provided to the space allocation module 72 and pricing module 74 to compute optimal space allocation between booking classes, and optimal prices of space in each booking class.

Quantitative forecasting may provide a useful tool to predict future demand for space in a market, however it can also have certain shortcomings. For example, quantitative forecasting may have a limited ability to predict demand in markets that are new to a carrier. Quantitative forecasting may also fail to take into account events, such as changes to the economy, that may affect demand.

Table 3 depicts an exemplary pickup table for search queries in a market. Table 3 may be generated, for example, based on data stored in the query database 14. The data in each cell of table 3 may define a number of spaces for which search queries were received prior to the time defined by the corresponding column for spaces departing on the departure interval corresponding to the cell. Search queries requesting more than one space may cause the data to be incremented by an amount equal to the number of spaces defined by the search query to reflect the number of spaces requested. The data in each cell may thereby correspond to an “intensity” of the search query activity. In cases where the search queries do not indicate a number of spaces, the intensity may be incremented by a default value, e.g., one space.

By way of example, presume the departure intervals and sample times of table 3 are each equal to one day, the market represented by table 3 represents an origin of New York and a destination of Paris, and departure interval “0” corresponds to Jul. 4, 2016. Under this set of presumptions, a search query received on Jun. 30, 2016 for flights from New York to Paris departing on Jul. 4, 2016 may cause in the number of search queries indicated by the cell in row 0/column E to be incrementally higher than if the search query had not been received, e.g., 202 as shown rather than 201 (assuming that the search query was for a single space). As with tables 1 and 2, the search period, departure interval, number of rows, and number of columns of table 3 are for exemplary purposes, and embodiments of the invention are not limited to any particular durations of time or sizes of table.

TABLE 3

| Departure | Time Prior to Departure | | | | | | | | |
|---|---|---|---|---|---|---|---|---|---|
| Interval | A | B | C | D | E | F | G | H | I |
| +4 | — | — | — | — | 199 | 119 | 73 | 43 | 27 |
| +3 | — | — | — | 337 | 198 | 122 | 73 | 46 | 28 |
| +2 | — | — | 548 | 328 | 208 | 119 | 72 | 46 | 25 |
| +1 | — | 912 | 560 | 326 | 202 | 126 | 74 | 43 | 29 |
| 0 | 1529 | 926 | 551 | 343 | 203 | 122 | 76 | 45 | 26 |
| −1 | 1521 | 916 | 557 | 338 | 197 | 123 | 75 | 45 | 28 |
| −2 | 1501 | 931 | 559 | 330 | 199 | 124 | 76 | 46 | 26 |
| −3 | 1481 | 924 | 549 | 333 | 204 | 121 | 74 | 45 | 27 |
| −4 | 1503 | 893 | 542 | 333 | 205 | 121 | 77 | 42 | 27 |

It has been determined that a positive correlation exists between the intensity of low fare search queries and the number of bookings ultimately received. Due to this correlation between the intensity of search queries and the number of bookings, statistical data derived from search queries may be useful in forecasting demand. Statistical data may include, for example, a number of queries received for a specific origin and destination, a time each query was received, a difference between the time of arrival and the requested departure date, or “date-to-departure” for each query, or any other data describing the query and/or the context of the query.

Using search query data to generate pickup curves may provide several advantages over using historical booking data alone. One advantage may be that the volume of search queries typically exceeds the number of booked seats by large factor. This may allow robust statistics to be determined at a higher level of granularity with respect to both time intervals and market sizes analyzed than is possible with historical booking data. Another advantage may be that present search query numbers may be predicative of future demand in a more direct way than historical booking data. For example, because search query volume is forward looking, it may be useful for predicting demand in markets where historical booking data is lacking, e.g., markets that are new to a carrier. Search query volume may also be responsive to events that affect demand, such as changes to the economy.

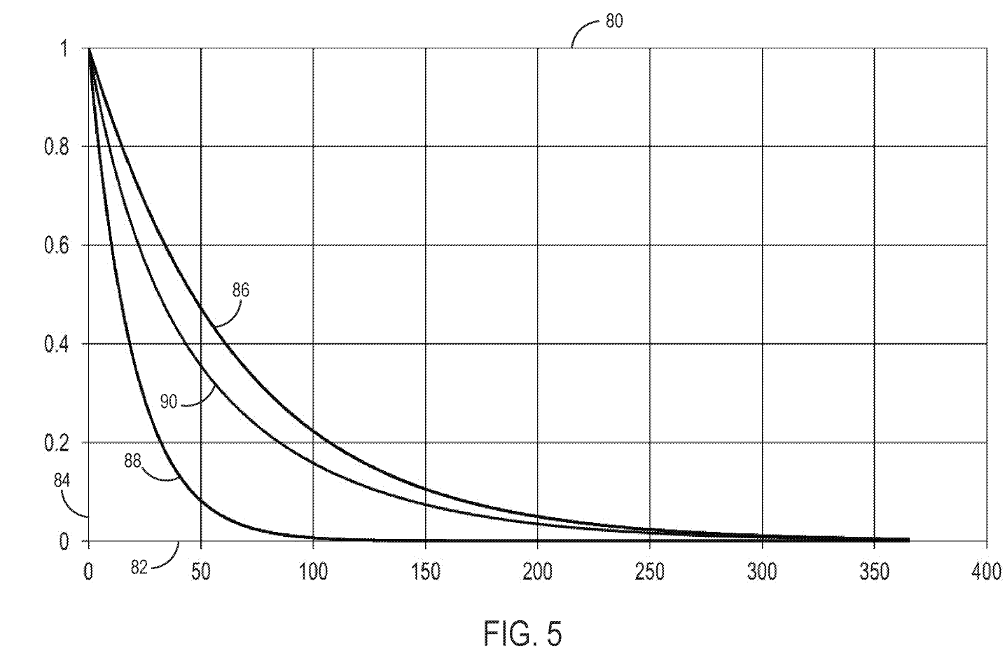

Referring now to FIG. 5, graph 80 is depicted with an additional exemplary pickup curve 90, which may represent search query data. In an embodiment of the invention, a pickup curve based on search query data may be generated in each market for which demand is to be forecast. These pickup curves may be analyzed to determine whether they improve forecasts generated from historical booking data of departed flights. The demand forecasting module 70 may use the search query data to modify the forecast in a particular market if it is determined that using the search query data improves the forecast quality in that market.

To achieve robust statistics, which typically require a large number of data points, forecasts based on historical booking data may be determined using data pooled across a large number of departure dates. For example, pickup curves based on historical booking data, such as pickup curves 86 and 88, may be based on departures occurring over a period of a year. In contrast, due to the relatively larger number of search queries received for travel in each market, robust pickup statistical data may be available using search query data collected over much shorter periods, such as for a particular day of departure.

For example, pickup curves based on data from the query database 14, such as pickup curve 90, may be generated based on a subset of the departure dates from which the booking data used to generate booking pickup curves, such as booking pickup curves 86 and 88, are drawn. These subsets may include a particular day of the week (e.g., search queries for departures on Tuesdays), a particular travel period (e.g., the week of spring break), or even individual days (e.g., the day before Thanksgiving). If indications are that the forecast would be improved by using search query data, the model pickup curve may be adjusted for flights that have yet to depart based on the query pickup curve pattern that provides a best fit.

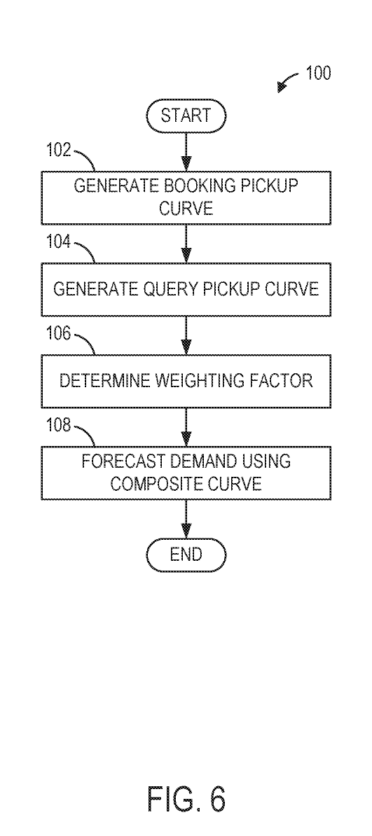

FIG. 6 illustrates a flow chart of a process 100 that may be executed by the demand forecasting module 70 to determine a weighting factor that may be used to incorporate search query data into a forecasting process. In block 102, the process 100 may generate a booking pickup curve for a market being analyzed. The market may comprise, for example, flights from an origin to a destination of a specific origin-destination pair. The average booking pickup curve may be generated based on departed flights in the market over an analysis period, e.g., the previous year. The booking pickup curve may be a normal pickup curve, and may be generated using reservation history records to determine the number of bookings and when the bookings were made relative to the departure time of flights in the market over the analysis period.

In block 104, the process 100 may generate a query pickup curve for the market. The query pickup curve may be generated using search query records to determine the number and/or intensity of search queries received for the departed flights in the market. In an embodiment of the invention, the historical query pickup curve may be based on the statistics of search queries received for the same departed flights used to generate the booking pickup curve. The query pickup curve may be generated using search query data from the full analysis period (e.g., a year), or from a subset of the analysis period, (e.g., a day, a week, or a month). In cases where the query pickup curve is generated using queries for flights with departure dates on or during a subset of the analysis period, pickup curves may be generated for multiple subsets covering the entire analysis period. The process 100 may then proceed to block 106.

In block 106, the process 100 may determine a weighting factor a. The weighting factor a may have a value that produces a best fit between a composite pickup curve and a target pickup curve. The composite pickup curve may be a weighted average of the booking pickup curve and the query pickup curve, and may be provided by:

f_{c}(t)=a×f_{bpc}(t)+(1−a)×f_{qpc}(t)

where f_{c}(t) represents the composite pickup curve, f_{bpc}(t) represents the booking pickup curve, and f_{qpc}(t) represents the query pickup curve.

For the market being analyzed, the value of the weighting factor a may be adjusted to provide a best fit between the composite pickup curve and the target pickup curve by minimizing an error function. For example, the value of weighting factor a may be adjusted to minimize a least squares type error function, such as:

Error(a)=Σₜ₌ₜ_{ₛₜₐᵣₜ}^{t}^{_{end}}[f_{c}(a,t)−f_{T}(t)]²

where f_{T}(t) represents the target pickup curve, tₛₜₐᵣₜ is the starting point for the period over which the curves are being compared, and t_{end} is the ending point for the period over which the curves are being compared. It should be understood that the above equation is for exemplary purposes only, and other methods may be used to determine the weighting factor a based on the composite pickup curve and the target pickup curve.

The target pickup curve may be generated based on different types of data depending on how and/or when the curve is generated. For example, when space on a flight is first made available for purchase (e.g., a year before departure), the amount of booking and search data for the flight may be limited. In this case, booking data for departed flights similar to the one being analyzed may be used to generate the target pickup curve.

As the departure date approaches, sufficient search data may become available to allow the target curve to be generated based at least in part on search data for the flight or market being analyzed. If the target pick-up curve differs significantly from the composite pickup curve, a new weighting factor may be determined by the demand forecasting module 70. At some point, the number of bookings for the flight may also become sufficient to generate the target pickup curve. As with the query booking pickup curve, if it appears that the booking pickup curve for the flight in question is deviating significantly from the composite pickup curve, the demand forecasting module 70 may recalculate the weighting factor a.

In any case, once the composite curve f_{c}(a, t) has been determined, the process 100 may proceed to block 108 and forecast demand for future flights using the composite curve corresponding to the subset of the analysis period for which demand is being determined.

Process 100 may be executed for each departure date in each market. The historical back-testing provided by process 100 may allow the usefulness of search query logs in predicting future demand to be evaluated on a per-market and per-flight basis. A decision to use the search query data may be made based on whether this back-testing indicates the search query data will improve demand forecasts. This new data source may be particularly useful when the demand forecasting module 70 is being used to predict demand for routes with limited historical booking data, such as new routes.

The number of bookings on departed flights may be relatively limited within a particular market. Therefore, to provide statistically robust booking curves, booking data for departed flights may be aggregated over a relatively long period of time, e.g., an entire year of departure dates for each market or a flight within the market. Because the number of search queries is typically much greater than the number of bookings for a specific market and/or flight, it has been determined that similarly robust query pickup curves may be generated using much smaller subsets of departure dates and/or flights.

This characteristic of query pickup curves may allow query pickup curves to be generated and used to predict demand for specific departure dates. This may enable embodiments of the demand forecasting module 70 to provide demand forecasts that more accurately reflect customer behavior than revenue management systems which lack the query database 14, or that do not generate pickup curves using search query statistics. The demand forecasting module 70 may also adjust forecast demand during the forecast period. Adjustments may be made in response to determining that a forward-looking or “real” booking or query pickup curve is deviating from one or more pickup curves used to predict demand for a particular market, flight, or departure date.

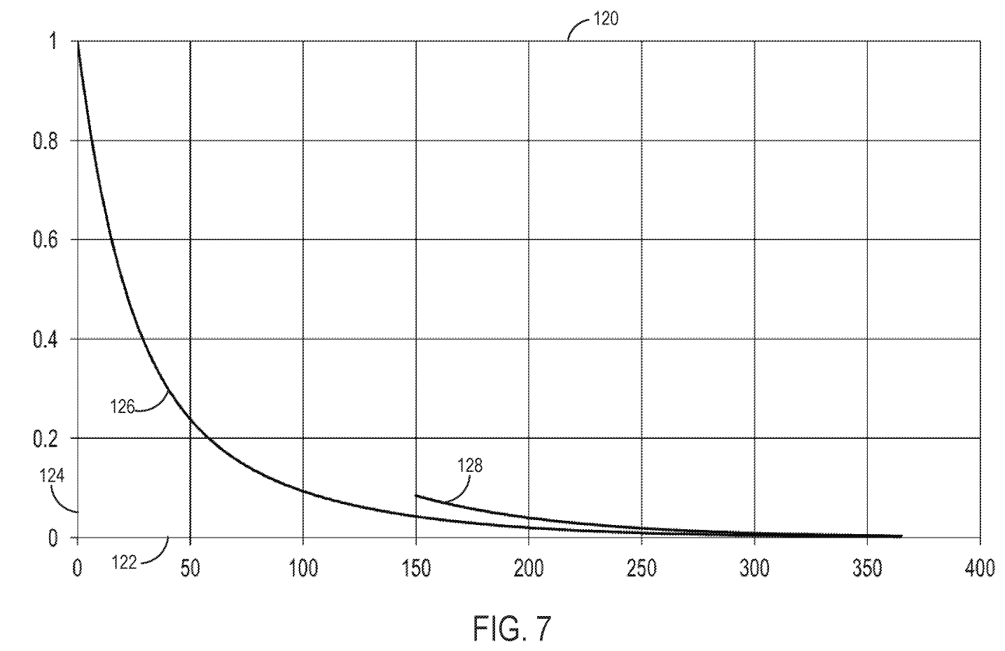

Referring now to FIG. 7, and for purposes of illustration only, an exemplary graph 120 includes horizontal axis 122 corresponding to a number of days until departure, and a vertical axis 124 corresponding to a number of search queries/bookings received for spaces in the market. The number of search queries/bookings represented by vertical axis 124 may be normalized to a total number of search queries/bookings received by the time of departure for the flight or market being analyzed.

Graph 120 includes a historical pickup curve 126, and a prospective pickup curve 128. In an embodiment of the invention, the historical pickup curve 126 may be the historical query pickup curve used by the demand forecasting module 70 to forecast demand for a particular market and/or flight, and the prospective pickup curve 128 may represent a partial pickup curve generated based on search queries received to a present point in time for one or more flights in the market. In an alternative embodiment of the invention, the historical pickup curve 126 may be the composite pickup curve used by the demand forecasting module 70 to forecast demand for a particular market and/or flight, and the prospective pickup curve 128 may represent a partial pickup curve generated based on bookings received to a present point in time for one or more flights in the market.

In the present example, prospective pickup curve 128 ends at a point on the graph 120 corresponding to a point in time 150 days prior to departure. This point in time may, for example, reflect the most recent search query data available in the query database 14, or the most recent booking data available from one or more reservation systems. As can be seen, the path of the prospective pickup curve 128 has begun to deviate from the historical pickup curve 126. This deviation may be indicative of an error in the initial forecast of demand for the market, the occurrence of an event which has affected demand, or some other change in the market.

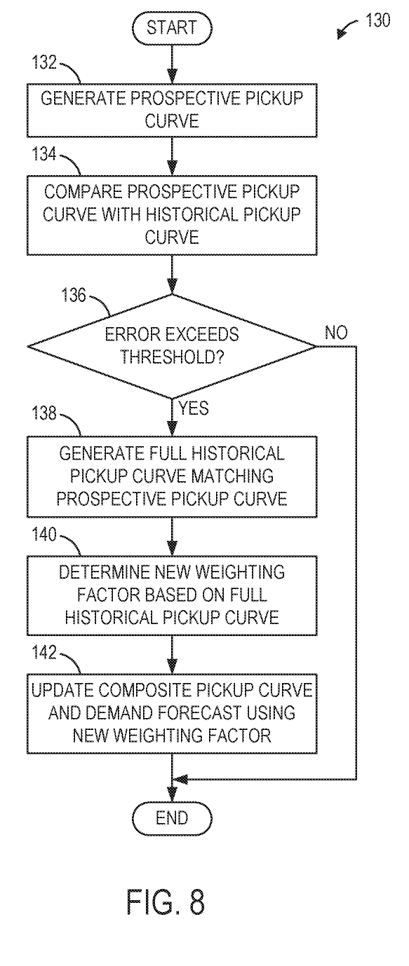

FIG. 8 illustrates a flow chart of a process 130 that may be executed by the demand forecasting module 70 to identify and correct inaccurate forecasts based on search query data for flights which have not yet departed. In block 132, the process 130 may generate a prospective pickup curve for a future date of departure in the market being analyzed. Because the prospective query pickup curve is forward-looking (i.e., the flights involved have not departed), the prospective pickup curve may be a partial pickup curve such as the prospective pickup curve 128 depicted in FIG. 7.

In block 134, the process 130 may compare the prospective pickup curve with the historical pickup curve used to generate the current demand forecast, e.g., a historical query, composite, booking, or target pickup curve. This comparison may involve generating an error based on the divergence of the prospective pickup curve and the historical pickup curve. For example, the error may be related to an area between the curves, a distance between the curves, or any other suitable parameter for characterizing the amount of divergence.

If the error does not exceed a predetermined threshold (“NO” branch of decision block 136), the process 130 may end without altering the current demand forecast. If the error exceeds the predetermined threshold (“YES” branch of decision block 136), the process 130 may proceed to block 138. In block 138, the process 130 may select, generate, or otherwise determine a full historical pickup curve that matches the prospective pickup curve. For example, the process 130 may compare a plurality of previously generated historical pickup curves to the prospective pickup curve, and select the historical pickup curve that best fits the prospective pickup curve. The process 130 may also generate the full historical pickup curve based solely on the prospective pickup curve using a partial curve matching algorithm.

In block 140, the process 130 may determine a new weighting factor a by substituting the full historical pickup curve for the previously used historical pickup curve. The process 130 may then proceed to block 142, update the composite pickup curve for the market being analyzed, and generate a new demand forecast based on the updated composite pickup curve. By providing a large number of data points relating to demand for spaces in advance of the date of departure, the search query logs may enable generation of robust statistics in the form of query pickup curves. These query pickup curves may enable more accurate forecasting of future demand, and may also allow correction of demand forecasts due to unexpected changes in demand.

In general, the routines executed to implement the embodiments of the invention, whether implemented as part of an operating system or a specific application, component, program, object, module or sequence of instructions, or a subset thereof, may be referred to herein as “computer program code,” or simply “program code.” Program code typically comprises computer-readable instructions that are resident at various times in various memory and storage devices in a computer and that, when read and executed by one or more processors in a computer, cause that computer to perform the operations necessary to execute operations and/or elements embodying the various aspects of the embodiments of the invention. Computer-readable program instructions for carrying out operations of the embodiments of the invention may be, for example, assembly language or either source code or object code written in any combination of one or more programming languages.

Various program code described herein may be identified based upon the application within which it is implemented in specific embodiments of the invention. However, it should be appreciated that any particular program nomenclature which follows is used merely for convenience, and thus the invention should not be limited to use solely in any specific application identified and/or implied by such nomenclature. Furthermore, given the generally endless number of manners in which computer programs may be organized into routines, procedures, methods, modules, objects, and the like, as well as the various manners in which program functionality may be allocated among various software layers that are resident within a typical computer (e.g., operating systems, libraries, API's, applications, applets, web based services, etc.), it should be appreciated that the embodiments of the invention are not limited to the specific organization and allocation of program functionality described herein.

The program code embodied in any of the applications/modules described herein is capable of being individually or collectively distributed as a program product in a variety of different forms. In particular, the program code may be distributed using a computer-readable storage medium having computer-readable program instructions thereon for causing a processor to carry out aspects of the embodiments of the invention.

Computer-readable storage media, which is inherently non-transitory, may include volatile and non-volatile, and removable and non-removable tangible media implemented in any method or technology for storage of information, such as computer-readable instructions, data structures, program modules, or other data. Computer-readable storage media may further include RAM, ROM, erasable programmable read-only memory (EPROM), electrically erasable programmable read-only memory (EEPROM), flash memory or other solid state memory technology, portable compact disc read-only memory (CD-ROM), or other optical storage, magnetic cassettes, magnetic tape, magnetic disk storage or other magnetic storage devices, or any other medium that can be used to store the desired information and which can be read by a computer. A computer-readable storage medium should not be construed as transitory signals per se (e.g., radio waves or other propagating electromagnetic waves, electromagnetic waves propagating through a transmission media such as a waveguide, or electrical signals transmitted through a wire). Computer-readable program instructions may be downloaded to a computer, another type of programmable data processing apparatus, or another device from a computer-readable storage medium or to an external computer or external storage device via a network.

Computer-readable program instructions stored in a computer-readable medium may be used to direct a computer, other types of programmable data processing apparatuses, or other devices to function in a particular manner, such that the instructions stored in the computer-readable medium produce an article of manufacture including instructions that implement the functions, acts, and/or operations specified in the flow charts, sequence diagrams, and/or block diagrams. The computer program instructions may be provided to one or more processors of a general purpose computer, a special purpose computer, or other programmable data processing apparatus to produce a machine, such that the instructions, which execute via the one or more processors, cause a series of computations to be performed to implement the functions, acts, and/or operations specified in the flow charts, sequence diagrams, and/or block diagrams.

In certain alternative embodiments, the functions, acts, and/or operations specified in the flow charts, sequence diagrams, and/or block diagrams may be re-ordered, processed serially, and/or processed concurrently consistent with embodiments of the invention. Moreover, any of the flow charts, sequence diagrams, and/or block diagrams may include more or fewer blocks than those illustrated consistent with embodiments of the invention.

The terminology used herein is for the purpose of describing particular embodiments only and is not intended to be limiting of the embodiments of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, actions, steps, operations, elements, and/or components, but do not preclude the presence or addition of one or more other features, integers, actions, steps, operations, elements, components, and/or groups thereof. Furthermore, to the extent that the terms “includes”, “having”, “has”, “with”, “comprised of”, or variants thereof are used in either the detailed description or the claims, such terms are intended to be inclusive in a manner similar to the term “comprising”.

While all of the invention has been illustrated by a description of various embodiments and while these embodiments have been described in considerable detail, it is not the intention of the Applicant to restrict or in any way limit the scope of the appended claims to such detail. Additional advantages and modifications will readily appear to those skilled in the art. The invention in its broader aspects is therefore not limited to the specific details, representative apparatus and method, and illustrative examples shown and described. Accordingly, departures may be made from such details without departing from the spirit or scope of the Applicant's general inventive concept.

What is claimed is:

1. A data warehouse system comprising:
one or more processors; and
a memory coupled to the one or more processors, the memory storing first data comprising a first database of query log records and instructions that, when executed by the one or more processors, cause the system to:
receive a plurality of search queries, each search query received at a reception time, and defining a departure time and an origin-destination pair; and
for each search query:
determine a time until departure from the reception time to the departure time of the search query, and
store, in a query log record associated with the origin-destination pair, second data indicating reception of the search query and the time to departure,
wherein each query log record indicates a number of spaces and the time to departure associated with each space for the origin-destination pair with which the query log record is associated.

2. The system of claim 1 wherein the instructions further cause the system to:
define an index including a plurality of fields each corresponding to a respective origin-destination pair, each field defining a location in the first database of each query log record that is associated with the respective origin-destination pair.

3. The system of claim 1 wherein the search queries are low fare search queries.

4. The system of claim 1 wherein the instructions further cause the system to:
receive a request to provide statistical data for a respective origin-destination pair for a period of time;
in response to receiving the request, retrieve one or more query log records from the first database, each of the one or more query log records being associated with the respective origin-destination pair and including data relating to search queries that define a respective departure time which falls within the period of time;
extract the second data from each of the retrieved query log records;
generate a first pickup curve depicting an intensity of search queries for the respective origin-destination pair with respect to the time to departure during the period of time based on the second data; and
forecast a demand for spaces for the respective origin-destination pair using the first pickup curve.

5. The system of claim 4 wherein the departure time defined by each of the one or more query log records has passed at the time the request is received.

6. The system of claim 4 wherein the period of time covers a plurality of departure intervals, and the instructions cause the system to forecast the demand for spaces for the respective origin-destination pair using the first pickup curve by:
querying a second database for third data that defines a plurality of bookings of spaces for the respective origin-destination pair that have departed during the period of time;
generating a second pickup curve using the third data, the second pickup curve depicting a number of bookings with respect to the time to departure during the period of time; and
generating a third pickup curve that is a weighted average of the first pickup curve and the second pickup curve,
wherein the demand for spaces is forecast for the respective origin-destination pair using the third pickup curve.

7. The system of claim 6 wherein the instructions further cause the system to, for at least one departure interval covered by the period of time:
determine a fourth pickup curve for the respective origin-destination pair;
determine a weighting factor that provides a best fit between the third pickup curve and the fourth pickup curve; and
forecast the demand for spaces for the respective origin-destination pair for a future departure interval using the third pickup curve with the weighting that provides the best fit,
wherein the fourth pickup curve is a target pickup curve.

8. The system of claim 7 wherein the instructions further cause the system to, for each future departure interval:
determine a partial pickup curve for the search queries that were satisfied by a respective travel solution for the respective origin-destination pair that is scheduled to depart during the future departure interval;
determine the third pickup curve having the best fit to the partial pickup curve; and
forecast the demand for spaces for the respective origin-destination pair for the future departure interval using the third pickup curve having the best fit to the partial pickup curve.

9. The system of claim 8 wherein each departure interval covers a day, and the period of time covers a year.

10. The system of claim 6 wherein the respective origin-destination pair is one of a plurality of origin-destination pairs comprising a travel network, and the instructions further cause the system to:
generate a separate first pickup curve for each departure interval for each origin-destination pair of the plurality of origin-destination pairs.

11. A method of managing a data warehouse system, the method comprising:
receiving a plurality of search queries by the data warehouse system, each search query received at a reception time, and defining a departure time and an origin-destination pair; and
for each search query:
determining a time until departure from the reception time to the departure time of the search query, and
storing, in a query log record associated with the origin-destination pair, second data indicating reception of the search query and the time to departure,
wherein each query log record is stored in a first database, and indicates a number of spaces and the time to departure associated with each space for the origin-destination pair with which the query log record is associated.

12. The method of claim 11 further comprising:
defining an index including a plurality of fields each corresponding to a respective origin-destination pair, each field defining a location in the first database of each query log record that is associated with the respective origin-destination pair.

13. The method of claim 11 further comprising:
receiving a request to provide statistical data for a respective origin-destination pair for a period of time;
in response to receiving the request, retrieving one or more query log records from the first database, each of the one or more query log records being associated with the respective origin-destination pair and including data relating to search queries that define a respective departure time which falls within the period of time;
extracting the second data from each of the retrieved query log records;
generating a first pickup curve depicting an intensity of search queries for the respective origin-destination pair with respect to the time to departure during the period of time based on the second data; and
forecasting a demand for spaces for the respective origin-destination pair using the first pickup curve.

14. The method of claim 13 wherein the departure time defined by each of the one or more query log records has passed at the time the request is received.

15. The method of claim 13 wherein the period of time covers a plurality of departure intervals, and forecasting the demand for spaces for the respective origin-destination pair using the first pickup curve comprises:
querying a second database for third data that defines a plurality of bookings of spaces for the respective origin-destination pair that have departed during the period of time;
generating a second pickup curve using the third data, the second pickup curve depicting a number of bookings with respect to the time to departure during the period of time; and
generating a third pickup curve that is a weighted average of the first pickup curve and the second pickup curve,
wherein the demand for spaces is forecast for the respective origin-destination pair using the third pickup curve.

16. The method of claim 15 further comprising, for at least one departure interval covered by the period of time:
determining a fourth pickup curve for the respective origin-destination pair;
determining a weighting factor that provides a best fit between the third pickup curve and the fourth pickup curve; and
forecasting the demand for spaces for the respective origin-destination pair for a future departure interval using the third pickup curve with the weighting that provides the best fit,
wherein the fourth pickup curve is a target pickup curve.

17. The method of claim 16 further comprising, for each future departure interval:
determining a partial pickup curve for the search queries that were satisfied by a respective travel solution for the respective origin-destination pair that is scheduled to depart during the future departure interval;
determining the third pickup curve having the best fit to the partial pickup curve; and
forecasting the demand for spaces for the respective origin-destination pair for the future departure interval using the third pickup curve having the best fit to the partial pickup curve.

18. The method of claim 17 wherein each departure interval covers a day, and the period of time covers a year.

19. The method of claim 15 wherein for the respective origin-destination pair is one of a plurality of origin-destination pairs comprising a travel network, and further comprising:
generating a separate first pickup curve for each departure interval for each origin-destination pair of the plurality of origin-destination pairs.

20. A computer program product for processing an online transaction, the computer program product comprising:
a non-transitory computer-readable storage medium; and
program code stored on the non-transitory computer-readable storage medium that, when executed by one or more processors, causes the processors to:
receive a plurality of search queries, each search query received at a reception time and defining a departure time and an origin-destination pair; and
for each search query:
determine a time until departure from the reception time to the departure time of the search query, and
store, in a query log record associated with the origin-destination pair, second data indicating reception of the search query and the time to departure,
wherein each query log record indicates a number of spaces and the time to departure associated with each space for the origin-destination pair with which the query log record is associated.
